(19) United States
(12) Patent Application Publication
(10) Pub. No.: US 2013/0148140 A1
(43) Pub. Date: Jun. 13, 2013

(54) SYSTEMS AND METHODS FOR INKJET PRINTING

(71) Applicant: GLOBAL GRAPHICS SOFTWARE LIMITED, Cambourne (GB)

(72) Inventor: Andrew William Bateman-Jones, Attleborough (GB)

(73) Assignee: GLOBAL GRAPHICS SOFTWARE LIMITED, Cambourne (GB)

(21) Appl. No.: 13/707,339

(22) Filed: Dec. 6, 2012

Related U.S. Application Data
(60) Provisional application No. 61/567,805, filed on Dec. 7, 2011.

(51) Int. Cl. G06K 15/02

(52) U.S. Cl. CPC G06K 15/1835
USPC 358/1.9

(57) ABSTRACT

A method of printing a document on a printing device which includes providing an output profile in a color space of the printing device, the printing device utilizing multiple device colorants; transforming a color space of the document to the color space of the printing device if the color space of the document is not the same as the color space of the printing device; and applying a colorant limiting transform to the color space of the document. The colorant limiting transform limits each device colorant based on a combined usage of the device colorants in the output profile. The method also includes printing the document on the printing device using the transformed profile.

### CROSS-REFERENCE TO RELATED APPLICATIONS

This application claims the benefit under 35 U.S.C. §119(e) of U.S. Provisional Patent Application Ser. No. 61/567,805 filed on Dec. 7, 2011, which is incorporated herein by reference.

### FIELD

The invention relates to systems and method for printing documents using an inkjet printer. The invention also relates to systems and method for managing ink load when printing documents using an inkjet printer.

### BACKGROUND

Over the last few years the use of inkjet printing has increased dramatically in digital production of printed matter. Historically inkjet has been used mainly for categories of work that use a relatively low coverage of ink and that have not required accurately controlled color reproduction, such as credit card statements, telephone bills and the like. More recently the quality achievable with high-speed inkjet has risen significantly and there is increased use of this technology for classes of printing where color quality matters and where the area of the page that is covered with ink has increased. Such classes include, for example, direct marketing, books and magazines, general commercial printing and the like. At the same time the speed of digital inkjet printers and presses has increased greatly.

Ink coverage can be described in terms of a percentage of Total Area Coverage, or TAC. For example, a page of black text may be quoted as having a TAC of 3%. When printing in color the areas of the page covered with each ink used are summed to produce the total coverage. In a typical full color inkjet press four inks are used: Cyan, Magenta, Yellow and Black (often abbreviated CMYK). In combination these colorants can simulate a wide variety of other colors. If all four inks are laid down across the whole page the TAC is said to be 400%; 100% of each of the four inks.

When printing with aqueous inks the majority of the liquid applied to the paper is water which must then be dried away. The amount of water added to the medium therefore increases with the TAC. This can lead to a number of process problems. For example, if the media being printed onto is paper-based it has a tendency to expand or stretch as water is added and holding registration between the various ink colors becomes harder. If inks are printed out of register elements of the page design can gain unwanted color fringes, or appear soft.

Furthermore, in some cases excessive water content can reduce the tensile strength of the medium. In addition, as the speed of presses increases the amount of time available to dry the medium is often reduced unless a longer or higher-power drier is added. Failure to balance drying power with water load on the medium may lead to uneven drying which can result in surface effects such as cockling or paper curl, reducing the quality of the final printed piece. Moreover, incompletely dried media can cause problems in post-press operations such as winding onto reels, registration for cutting and the like. This can reduce productivity or final print quality.

### BRIEF SUMMARY

One embodiment is a method of printing a document on a printing device which includes providing an output profile in a color space of the printing device, the printing device utilizing multiple device colorants; transforming a color space of the document to the color space of the printing device if the color space of the document is not the same as the color space of the printing device; and applying a colorant limiting transform to the color space of the document. The colorant limiting transform limits each device colorant based on a combined usage of the device colorants in the output profile. The method also includes printing the document on the printing device using the transformed profile.

Another embodiment is a computer readable storage medium having processor-executable instructions, the processor-executable instructions when installed onto a system enable the system to perform actions. The actions include providing an output profile in a color space of the printing device, the printing device utilizing multiple device colorants; transforming a color space of the document to the color space of the printing device if the color space of the document is not the same as the color space of the printing device; and applying a colorant limiting transform to the color space of the document. The colorant limiting transform limits each device colorant based on a combined usage of the device colorants in the output profile. The actions also include printing the document on the printing device using the transformed profile.

Yet another embodiment is a system for printing a document that includes a printing device; and at least one processor. The at least one processor is configured and arranged to provide an output profile in a color space of the printing device, the printing device utilizing multiple device colorants; transform a color space of the document to the color space of the printing device if the color space of the document is not the same as the color space of the printing device; and apply a colorant limiting transform to the color space of the document. The colorant limiting transform limits each device colorant based on a combined usage of the device colorants in the output profile. The processor is also configured and arranged to print the document on the printing device using the transformed profile.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed; and

FIG. 2 is a schematic flow chart of one embodiment of printing a document using colorant-limiting transform, according to the invention.

### DETAILED DESCRIPTION

The invention relates to systems and method for printing documents using an inkjet printer. The invention also relates to systems and method for managing ink load when printing documents using an inkjet printer.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of printer that includes a processor. Suitable printers and mobile devices typically include mass memory and typically include methods for communication with other devices including mobile devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a printer.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

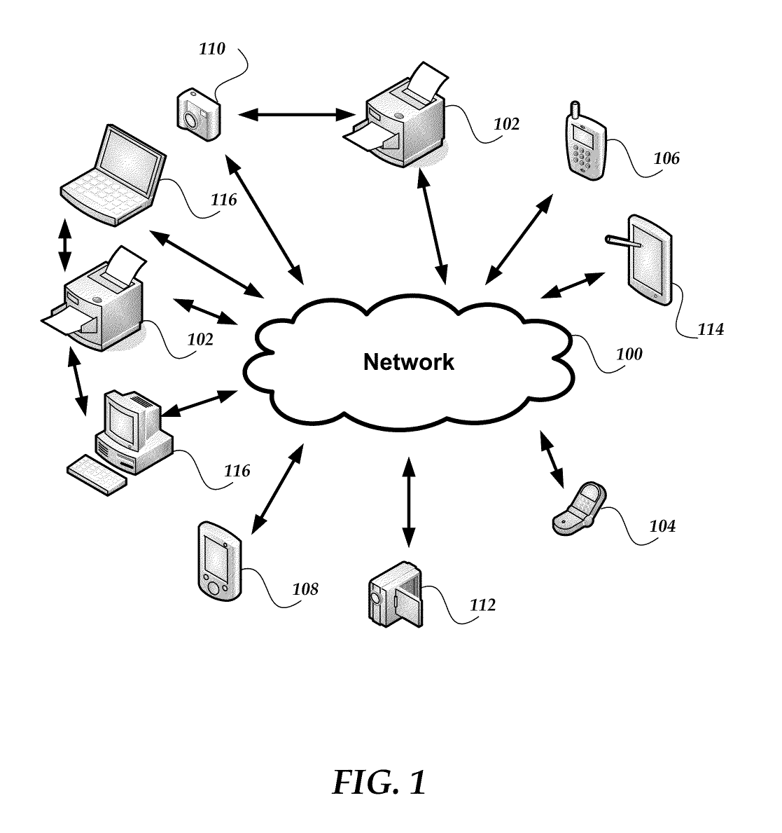

FIG. 1 illustrates one embodiment of an environment for the invention. In FIG. 1, a network environment is illustrated, but it will be understood that the invention is also applicable to unnetworked devices (e.g., printers and computers) as well. It will be understood that the network environment can be a local area network, a wide area network, or any combination thereof. It will also be understood that the network can include devices, other than those illustrated, coupled to the network and that there may be multiple devices of each type illustrated connected to the network.

The illustrated environment of FIG. 1 includes a network 100 to which is attached, either directly or through other devices, and one or more printers or presses 102. Unless otherwise indicated, the terms “printer” and “press” are used interchangeably herein. Other devices that can be attached to the network or to a printer/press include cell phones 104, smart phones 106, personal data assistants (PDA's) 108, cameras 110, video cameras 112, tablet or slate computers 114, and computers/servers 116 (e.g., desktop or laptop computers or servers). Other devices can optionally be attached to the network such as portable storage devices (e.g., compact discs, DVDs, memory sticks, flash drives, or other optical or magnetic storage media) and the like. Any of these devices can be connected directly to the network or via another device. A device can optionally be connected directly to a printer 102 through a wired or wireless connection or can be connected to the printer through the network. Attachment to the network or to devices in the network can be wired or wireless connection or any combination thereof.

The printer or press may include a processor that can process the document and a memory unit for storage of the documents or portions of the document. Alternatively or additionally, the document may be stored or processed completely or partially on another device such as, for example, a computer or server. The printer or press includes a print engine for printing the document. For this application, the printer or press is an inkjet printer or press or any other printer/press that prints ink onto a medium, such as paper, plastic sheets, fiber, or any other suitable medium. In particular, the printer or press is a device that prints onto a medium using a colorant (e.g., ink) that includes a solvent or dispersant. The solvent or dispersant can be water or any other suitable solvent or dispersant.

Over-inking and excessive water load is a known problem in the previous use of low-speed inkjet proofing printers in the graphic arts. Excess ink can lead to ink spread, unattractive surface effects on the media and, in extreme cases, to ink running on the paper surface. Conventional solutions to this challenge include the construction of a color profile that addresses both the colorant limiting and corrects color reproduction at the same time; there is no clear separation of responsibility for colorant limiting and for profile creation. The consequences of incorrect or missing ink limitation in the case of a graphic arts proofer are also significantly less costly than those on a high-speed inkjet press: the most likely expense resulting will be from a need to re-build a profile correctly, re-print a small number of jobs, and potentially clean a roller or two.

While this concern is exemplified for a high-speed inkjet press using aqueous inks solutions, it may be equally applicable to other current and future technologies where a clear separation of responsibilities is desirable between color management and limitation of ink coverage. This includes both other ink formulations on an inkjet press, and other colorant technologies, such as toners and solid inks.

In at least some embodiments, the system separates the control of the two processes of ink limitation and achieving color correctness, allowing them to be performed by different entities, often on different sites. It is also aimed at preventing or reducing the risk of over-inking by a press or printer both while profiling a printer/press and while running production jobs using a profile so created. In particular, TAC should not be allowed to rise above a predefined limit for any significant area of a page. The ink limit to be applied varies by media type.

In the case of an inkjet press the supplier of the press typically desires to control colorant limiting in such a way that the press user cannot accidentally encounter reduced print quality or productivity by over-inking. At the same time the press user may desire to be able to create his own color profiles. For example, the user may create a color profile to use a type of paper that has not been profiled by the press supplier in advance and still achieve correct color reproduction.

As digital press speeds continue to rise it is desirable to ensure that processing in the digital front end (DFE) that drives the press does not prevent the press from running at engine speed, because a reduction in throughput can directly impact the press user's return on investment in the press. A further goal is to ensure that the separation of responsibility and risk reduction do not inadvertently increase processing requirements to such an extent that they reduce the throughput of the press.

Historically attempts have been made to add an ink-limiting step into press DFEs by applying 1-dimensional (1D) transforms (often mediated as look-up tables, or LUTs) to each color channel in turn. Unfortunately such 1D transforms must significantly reduce the gamut of printable colors. The only way to limit TAC to 260%, for instance, with 1D transforms is to divide the maximum TAC across those channels in a predetermined way. If divided equally that would mean that each would be limited to only 260%/4, or 65% coverage. While such an approach may work reasonably well on those colors that require three or more colorants to reproduce, it may lead to very weak and washed-out reproduction of colors printed, for example, with pure primaries, e.g. cyan.

The digital front end (DFE) in a full-color high-speed digital production press, and other inkjet printers and presses, can include a color management module (CMM) which applies color management to the colors used within each print job to ensure that the printed piece represents the colors intended by the designer as accurately as possible.

Color management workflows are complex, and can include a wide variety of special cases representing different routes taken through the system on a typical CMYK device, depending on what color space is presented to the CMM. A graphically rich content format such as the Portable Document Format (PDF) allows the designer and the tools that he uses to record data in a number of color spaces that can be divided into device spaces and device-independent spaces.

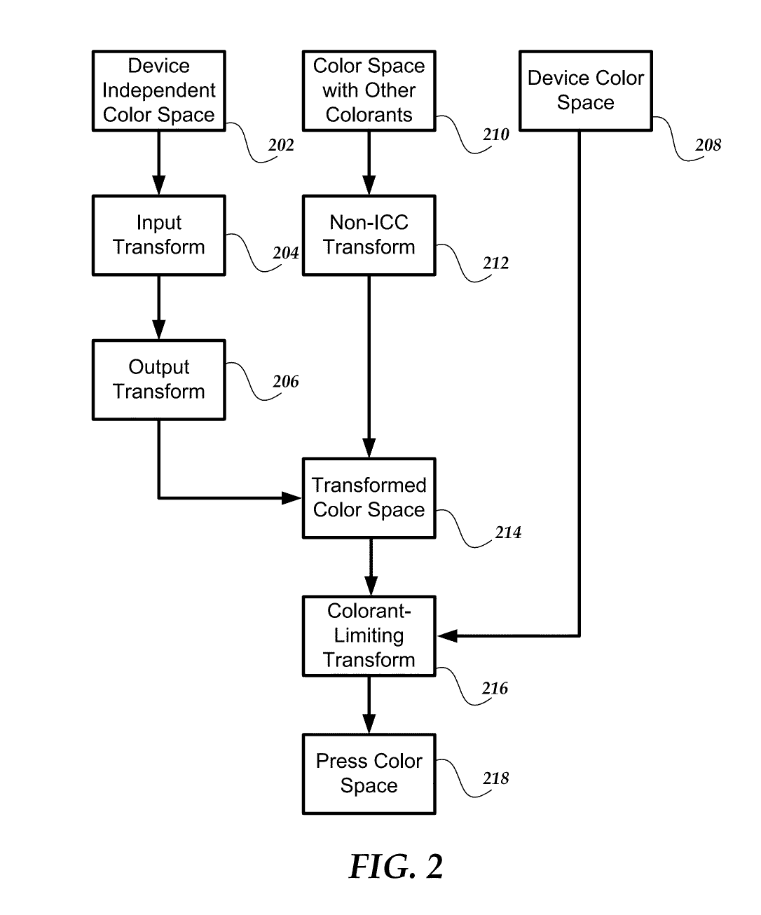

FIG. 2 is a diagram illustrating examples of the flow of different types of data in different color spaces. For example, data 202 in device-independent spaces include, in PDF terminology, Lab, ICCBased, CalGray and CalRGB. This data can be transformed using an input transform 204 into a universal device-independent color space, for example, XYZ. This input transform 204 can vary by color space: Lab is a static space and therefore can use a pre-built transform; CalRGB and CalGray are configurable within the PDF, and therefore can use specific transforms; and ICCBased uses color profiles as defined by the International Color Consortium (ICC). A second color transform 206 can be applied to convert the data from XYZ into a transformed color space 214 in the device color space of the press. Alternatively, a single transform may be used to covert the data directly from its original form to the transformed color space 214.

Device spaces 208 in which all of the colorants are reflected in the output color space of the device can be passed through as-is unless the CMM has been configured to apply a default input profile to them, in which case they could be treated as if they had been ICCBased, as described above.

Device spaces 210 which include colorants that are not present on the device may be processed through a non-ICC transform 212 to produce the transformed color space 214. In some cases this transform may use, for example, the algorithms defined for RGB to CMYK transformations in the PostScript Reference Manual or the algorithms provided in the PDF Reference Manual for DeviceN and NChannel color spaces. Device spaces representing spot or special colorants may be converted to CMYK using an algorithm provided within the color space definition (if supplied in, for example, a PostScript or PDF file), or may use some other transformation. Some DFEs may include look-up tables to, for example, XYZ or Lab, indexed by colorant name for separations taken from known color systems such as those from Pantone Inc; the resulting value could then be passed through the same output profile as would a device independent color space.

After performing any necessary transform to obtain a transformed color space 214 in the desired color space, as described above, a colorant-limiting transform 216 is applied. The colorant-limiting transform can consume, for example, color definitions in CMYK and transform them to altered color definitions in CMYK to ensure that the selected maximum ink coverage is not exceeded. The press/printer 218 then prints the document using the transformed color definitions.

In at least some embodiments, the colorant-limiting transform is a relatively simple algorithmic transform in order to limit the processing power and RAM required. The colorant-limiting transform does not need to be a sophisticated algorithm, or to relate significantly to the detailed color reproduction of the device. In one embodiment the algorithm takes two parameters: the maximum TAC (e.g. 260%) and the maximum area coverage for any individual colorant (e.g. 100%). In at least some embodiments, the maximum TAC is in the range from 100 to 350% or in the range from 180 to 320% or in the range from 240 to 320% or in the range from 180 to 240%. In at least some embodiment, the maximum area coverage for any individual colorant is in the range from 50 to 140% or in the range from 50 to 120% or in the range from 50 to 100% and may be different for one or more of the colorants. In other embodiments, the algorithm may include more parameters, such as, for example, the relative contribution of each colorant to solvent or dispersant (e.g., water) deposition, e.g. 120% for K, 100% for each of C, M and Y. This may be desirable because, for example, some digital presses use ink droplets of different sizes for each colorant. Another possible parameter is separate maximum area coverage for each colorant rather than a single number for all, e.g. 80% for K, 100% for each of C, M and Y.

In some embodiments, the colorant-limiting transform may make use of a look-up table (LUT). Such a table would allow the input CMYK values to be used as indices in order to read the corresponding output CMYK values. In at least some embodiments, a LUT would ideally represent at least 256 levels of each colorant, from 0 to 100% coverage. LUTs of this form are typically incomplete because they would otherwise require too many entries, and, instead, interpolation is performed to calculate the output values for input values that do not correspond exactly to an index in the LUT.

One example of a format for encoding LUTs of this form is as a DeviceLink profile as defined by the ICC. (See, for example, ISO 15067-1 which is incorporated herein by reference.) Accordingly, in some embodiments the colorant-limiting transform may make use of a DeviceLink profile. Such a profile provides a mechanism for transforming from one color space to another, where the two color spaces differ in one or more of colorants, in gamut, in tone reproduction, and so on.

DeviceLink profiles are widely used when emulating the output from one device on another. An example would be the emulation of a printing press that performs according to ISO 126457-2 (e.g. as represented using the measurements published by Fogra as Fogra39), incorporated herein by reference, on a proofing printer. Such emulation transforms may be included at the same point in a color management process chain as the colorant-limiting transform.

Use of a DeviceLink profile in a colorant-limiting transform is not a use case for which DeviceLink profiles were contemplated or defined or for which they are currently used. In addition, the existing tool sets for creation of DeviceLink profiles are incomplete for creation of a DeviceLink profile that would be suitable for use in a colorant-limiting transform. A new tool set, or an extension to an existing tool set, would be required to create appropriate DeviceLink profiles. For example, the creation of a DeviceLink profile may include two pre-existing profiles, e.g. one for a proofing printer, and one for a press color space that the proofing printer should emulate. Both of those profiles can be created, for example, by printing test pages containing test patches and measuring them; one on the proofing printer, and one on the press, for instance. In at least one embodiment, for use in ink limitation, the profile creation process could use one pre-existing profile created in that way that describes the color characteristics of the inkjet press. There is not, however, any physical device to measure for the reduced ink coverage end of the combined transform. Instead the creation process could construct a description of a synthetic device, e.g. by constructing a new profile from just those data points in the measured data from the inkjet press that have a TAC below the specified threshold levels.

In at least some embodiments, different values for the parameters for an algorithmic embodiment, or different DeviceLink profiles or other LUTs, may be used for different media (e.g. coated paper and uncoated paper) to reduce or minimize risk and simultaneously take advantage of the full color gamut achievable on each media type. At least some embodiments may include an automated look up of pre-defined parameter sets, profiles or LUTs based on information about the media entered by the user, or measured directly by the press/printer or associated equipment.

In some instances, the addition of a colorant-limiting transform to an existing system without other changes might lead to inaccurate color reproduction of device-independent colors. To address this issue, it may be useful to recreate an output profile used to transform from XYZ into CMYK. This can be done using the standard tools for profile creation (many tools are available from many different vendors). Profile creation typically involves printing and measuring a number of sample pages, each having one or more color patches. Typically the profile creation is performed with the appropriate colorant-limiting transform in-place. Accordingly, the system will not typically over-ink the output, even when making the profile. The resulting profile does not describe the press/media/ink/resolution/screening combination per se, but how the CMM sees that device through the colorant-limiting transform.

Creation of the profile once the colorant-limiting transform is in place means that the transform can be relatively simple because any non-linearity and other complexities in the press' color reproduction behavior will be addressed by the profile. Thus the final color reproduction will continue to be as accurate as is achievable on that press/media without running the risk of over-inking.

The diagrams and description above is addressed at the most common current implementation of digital production presses, to print in CMYK. All stages may be generalized to address other press color spaces, such as HiFi and PhotoInk spaces, including Hexachrome and IndiChrome.

The colorant-limiting transform is not limited to convert colors described in a device color space into printable colors in the same device color space. For example, the previous stages of the CMM may instead convert into a pre-defined normalized color space, and the colorant-limiting transform may convert from that normalized color space into the device space. Possible examples of such processing might be to use a nominated RGB color space (e.g. sRGB) as the normalized color space for a CMYK device. Alternatively, CMYK may be used as the normalized color space for a Photolnk device (i.e. a device using various strengths of CMYK inks, such as Cyan, light Cyan,

Magenta, light Magenta, Yellow, Black and light Black). The normalized color space may also match the press color space.

The addition of a separate process with its own configuration allows creation or selection of an output profile for processing of device-independent colors that can be carried out by different people at a different time to the instantiation and configuration of the colorant limiting. A digital press manufacturer can implement an embodiment of this system in their DFEs, including configuration for appropriate media types. Output profiles for use in the CMM in the DFE can be created by the press vendor (e.g. for commonly used or reference media types) or by the print company themselves.

By adding a step into the color transformation chain that limits the total ink density of output pixels, significant advantages can be gained. In at least some embodiments, there is a clear division between provision of the colorant-limiting transform and its parameters and the creation and use of an output profile, thus providing an equally clear division of responsibility. The press vendor may take ownership of the colorant-limiting transforms and therefore of protecting the press user from reduced output quality or productivity. The press user may take ownership of creation and use of color profiles for new media types.

In at least some embodiments, the algorithm, DeviceLink or LUT used for transformations, or parameters applied using the algorithm may be easily replaced or amended for different contexts, e.g. changing output resolution or media type. In at least some embodiments, high performance can be achieved by integration of the colorant-limiting transform into the CMM. In at least some embodiments, the transformation is applied to the source data which is typically significantly lower resolution than the final output raster data which reduces the volume of data to be handled, increasing performance. In at least some embodiments, an implementation may choose to cache transform results for even higher performance

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of printing a document on a printing device, the method comprising:
providing an output profile in a color space of the printing device, the printing device utilizing a plurality of device colorants;
transforming a color space of the document to the color space of the printing device if the color space of the document is not the same as the color space of the printing device;
applying a colorant limiting transform to the color space of the document, wherein the colorant limiting transform limits each device colorant based on a combined usage of the device colorants in the output profile; and
printing the document on the printing device using the transformed profile.

2. The method of claim 1, wherein the colorant limiting transform utilizes at least two parameters, the at least two parameters comprising a maximum total area coverage for all colorants combined and a maximum area coverage for any one colorant.

3. The method of claim 2, wherein the at least two parameters are medium dependent.

4. The method of claim 2, wherein the colorant limiting transform utilizes a separate maximum area coverage parameter for each colorant.

5. The method of claim 2, wherein the colorant limiting transform utilizes parameters representing relative contribution of each colorant to solvent or dispersant deposition.

6. The method of claim 2, wherein the colorant limiting transform utilizes parameters representing relative droplet size of each colorant.

7. The method of claim 1, wherein the colorant limiting transform utilizes a look-up-table.

8. The method of claim 1, wherein the colorant limiting transform utilizes a DeviceLink profile.

9. The method of claim 1, further comprising specifying a medium upon which the document is to be printed, wherein the colorant limiting transform includes medium-dependent parameters.

10. A computer readable storage medium having processor-executable instructions, the processor-executable instructions when installed onto a system enable the system to perform actions, comprising:
receiving an output profile in a color space of a printing device, the printing device utilizing a plurality of device colorants;
transforming a color space of the document to the color space of the printing device if the color space of the document is not the same as the color space of the printing device;
applying a colorant limiting transform to the color space of the document, wherein the colorant limiting transform limits each device colorant based on a combined usage of the device colorants in the output profile; and
printing the document on the printing device using the transformed profile.

11. The computer readable storage medium of claim 10, wherein the colorant limiting transform utilizes at least two parameters, the at least two parameters comprising a maximum total area coverage for all colorants combined and a maximum area coverage for any one colorant.

12. The computer readable storage medium of claim 11, wherein the at least two parameters are medium dependent.

13. The computer readable storage medium of claim 11, wherein the colorant limiting transform utilizes a separate maximum area coverage parameter for each colorant.

14. The computer readable storage medium of claim 10, wherein the colorant limiting transform utilizes a look-up-table.

15. A system for printing a document, the system comprising:
a printing device; and
at least one processor, the at least one processor is configured and arranged to
receive an output profile in a color space of the printing device, the printing device utilizing a plurality of device colorants;
transform a color space of the document to the color space of the printing device if the color space of the document is not the same as the color space of the printing device;
apply a colorant limiting transform to the color space of the document, wherein the colorant limiting transform limits each device colorant based on a combined usage of the device colorants in the output profile; and
direct the printing device to print the document on the printing device using the transformed profile.

16. The system of claim 15, wherein the printing device comprises the at least one processor.

17. The system of claim 15, wherein the at least one processor is disposed in a computer or server coupled to the printing device.

18. The system of claim 15, wherein the colorant limiting transform utilizes at least two parameters, the at least two parameters comprising a maximum total area coverage for all colorants combined and a maximum area coverage for any one colorant.

19. The system of claim 18, wherein the at least two parameters are medium dependent.

20. The system of claim 18, wherein the colorant limiting transform utilizes a separate maximum area coverage parameter for each colorant.

21. The system of claim 15, wherein the colorant limiting transform utilizes a look-up-table.
